(19) United States
(12) Patent Application Publication
(10) Pub. No.: US 2026/0200531 A1
(43) Pub. Date: Jul. 16, 2026

(54) VEHICLE HAVING BATTERY PACK VENTING

(71) Applicant: FCA US LLC, Auburn Hills, MI (US)

(72) Inventors: Paul Billock, Auburn Hills, MI (US); Gary Marzetti, Auburn Hills, MI (US)

(21) Appl. No.: 19/017,899

(22) Filed: Jan. 13, 2025

(51) Int. Cl. B62D 21/17; H01M 50/249; H01M 50/35

(52) U.S. Cl. CPC B62D 21/17; H01M 50/249; H01M 50/35; H01M 2220/20

(57) ABSTRACT

A venting system for a vehicle includes at least one vent connected to a housing of the battery pack that is in communication with a conduit defined by at least one of a first hollow longitudinally extending rail of a frame assembly of the vehicle and a second hollow longitudinally extending rail of the frame assembly by a connection pipe that extends between the housing of the battery pack and the conduit. The venting system defines a flow path were the gases generated by the plurality of battery cells exit the battery pack through the vent and enter the connection pipe before entering the conduit defined by at least one of the first and second hollow longitudinally extending rails and travelling therethrough to at least one outlet port that directs the gases away from the passenger cabin.

### FIELD

The present disclosure relates to a vehicle having battery pack venting.

### BACKGROUND

This section provides background information related to the present disclosure which is not necessarily prior art.

Vehicles with electric propulsion systems are becoming increasingly more common. Some electrically propelled vehicles include an electric drive motor at each wheel of the vehicle, and some electrically propelled vehicles include a front electric drive motor for rotating the front wheels of the vehicle and/or a rear electric drive motor for rotating the rear wheels of the vehicle. In either case, the electric drive motors receive power from a battery pack that includes a plurality of battery cells therein. Example battery cells include lithium-ion battery cells and lithium-metal battery cells.

Lithium-ion and lithium-metal battery cells sometimes undergo a process called thermal runaway during failure conditions. Thermal runaway may result in a rapid increase of battery cell temperature accompanied by the release of various gases, which in some cases may be flammable. Accordingly, in the event of a thermal runaway, it is desirable that the vehicle include features that assist in venting the various gases away from the battery pack and the vehicle.

### SUMMARY

This section provides a general summary of the disclosure, and is not a comprehensive disclosure of its full scope or all of its features.

According to an aspect of the present disclosure, there is provided a vehicle that may include a frame assembly including a first hollow longitudinally extending rail and a second hollow longitudinally rail; a vehicle body defining a passenger cabin attached to and supported by the frame assembly; a battery pack attached to and supported by the frame assembly, the battery pack including a plurality of battery cells housed therein; and a venting system configured to direct gases generated by the plurality of battery cells away from the passenger cabin, wherein the venting system includes at least one vent connected to a housing of the battery pack and in communication with a conduit defined by at least one of the first and second hollow longitudinally extending rails by a connection pipe that extends between the housing of the battery pack and the conduit, and wherein the venting system defines a flow path were the gases generated by the plurality of battery cells exit the battery pack through the vent and enter the connection pipe before entering the conduit defined by at least one of the first and second hollow longitudinally extending rails and travelling therethrough to at least one outlet port that directs the gases away from the passenger cabin.

According to the aspect, each of the first and second hollow longitudinally extending rails includes an outer C-shaped panel that is connected to an inner C-shaped panel, and an inlet port is formed in a side surface of the inner C-shaped panel that receives the gases from the connection pipe.

According to the aspect, the venting system includes a first outlet port located at a front of the vehicle and a second outlet port located aft of the passenger cabin.

According to the aspect, the first outlet port is an open end of the at least one of the first and second hollow longitudinally extending rails, and the second outlet port is an aperture provided in the at least one of the first and second hollow longitudinally extending rails.

According to the aspect, each of the first and second hollow longitudinally extending rails includes an outer C-shaped panel that is connected to an inner C-shaped panel, and the second outlet port is formed in a side surface of the outer C-shaped panel.

According to the aspect, each of the first and second hollow longitudinally extending rails includes an outer C-shaped panel that is connected to an inner C-shaped panel, and the second outlet port is formed in a bottom surface of the outer C-shaped panel.

According to the aspect, the vent is configured to open and permit the gases to exit the battery pack after a predetermined pressure in the battery pack is reached.

According to the aspect, the predetermined pressure is 100 bar.

According to the aspect, the connection pipe is formed of a material that is resistant to a temperature of the gases generated by the plurality of battery cells.

According to the aspect, the connection pipe may be formed of a metal material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example vehicle that may have a venting system for an electric battery of the vehicle, according to a principle of the present disclosure;

FIG. 2 is a schematic illustration of the example vehicle illustrated in FIG. 1;

FIG. 3 is an overhead perspective view of a frame of the vehicle illustrated in FIG. 1 that supports the electric battery of the vehicle and includes the venting system according to a principle of the present disclosure;

FIG. 4 is a partial cross-sectional view along line 4-4 of FIG. 3, illustrating the venting system according to a principle of the present disclosure; and

FIG. 5 is a cross-sectional view of one of the longitudinally extending rails illustrated in FIG. 3 at a location where the gases generated during thermal runaway may exit the venting system according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

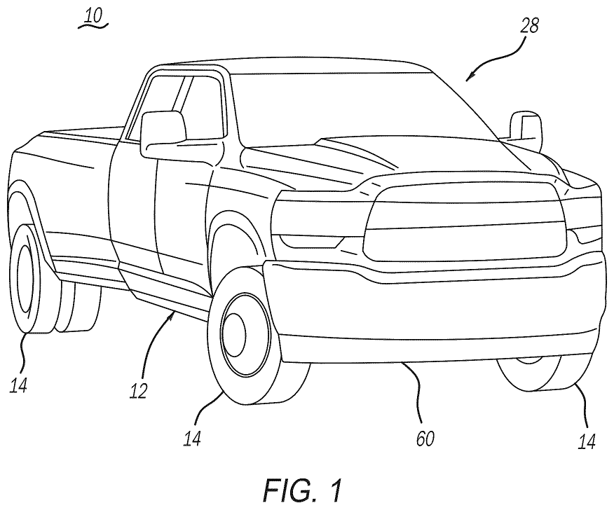

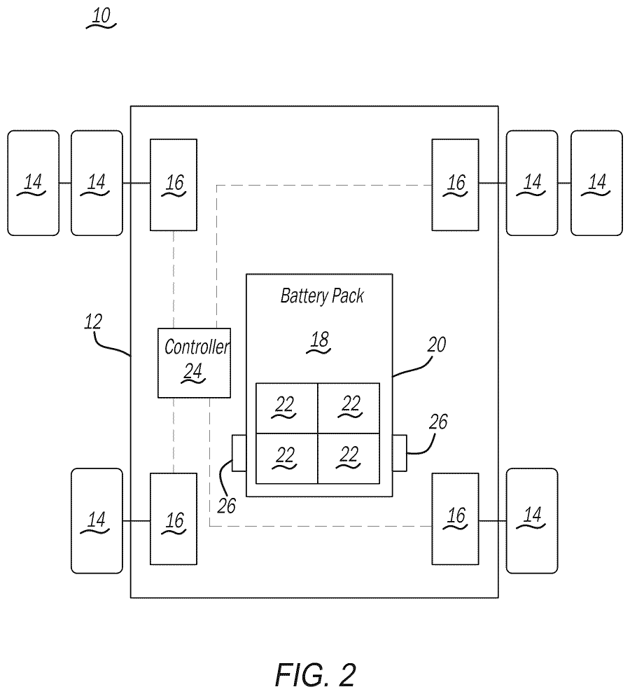

With reference to FIGS. 1 and 2, an example electric vehicle 10 according to the present disclosure is illustrated. Vehicle 10 includes a body 12, a plurality of wheels 14. In the illustrated embodiment, each wheel 14 is driven using a respective electric drive module 16 that receives electric power from a battery pack 18 having a housing 20 that encases a plurality of battery cells 22. Example battery cells 22 include lithium-ion battery cells, lithium-metal battery cells, and combinations thereof. It should be understood, however, that other types of battery cells 22 known to one skilled in the art may be used, without limitation. Housing 20 is preferably formed of a rigid metal material (e.g., steel, aluminum, and the like) that is resistant to puncture and is non-flammable.

While FIG. 2 illustrates four electric drive modules 16 such that each wheel 14 can be driven by a single electric drive module 16, it should be understood that vehicle 10 may include a single electric drive module 16 for driving a pair of wheels 14 (e.g., for driving the pair of front wheels 14 or the pair of rear wheels 14), or may include a pair of electric drive modules 16 with one of the electric drive modules 16 driving the front pair of wheels 14 and another of the electric drive modules 16 driving the rear pair of wheels 14. Regardless of the configuration selected, it should be understood that electric drive modules 16 receive a voltage or current from battery pack 18 that is utilized by the electric drive module 16 to drive the wheels 14 of the vehicle 10.

Vehicle 10 also includes a controller 24 in communication with each of the drive modules 16 and in communication with the battery pack 18. Controller 24 may be used to control electric drive modules 16 to control a speed of vehicle 10 and may also be used to monitor and/or communicate with various systems of vehicle such as an HVAC system (not shown), a vehicle braking system (not shown), and any other system that may be part of vehicle 10.

As noted above, battery cells 22 may sometimes undergo a process called thermal runaway during failure conditions of the battery cell(s) 22. Thermal runaway may result in a rapid increase of battery cell temperature accompanied by the release of various gases, which in some cases may be flammable. Example gases that may be released during a thermal runaway event include hydrogen (H₂), carbon monoxide (CO), carbon dioxide (CO₂), and various hydrocarbons including, but not limited to, methane, ethane, ethylene, acetylene, propane, cyclopropane, and butane. As these gases are released and the temperature of battery pack 18 increases, the pressure within battery pack 18 also increases. Battery pack 18, therefore, may include a plurality of vents 26 that may include a pressure-release mechanism (not shown) that will open and permit the gases to escape the battery pack 18. An example pressure that opens the pressure-release mechanism may be, for example, 100 bar.

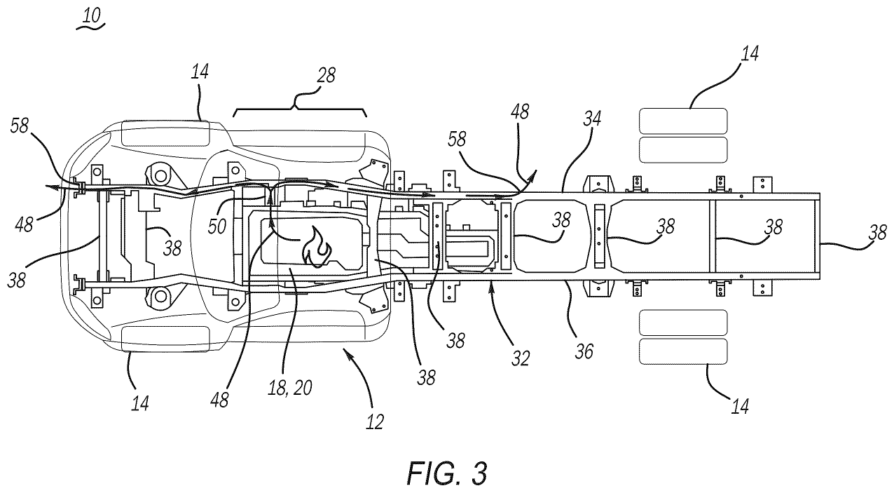

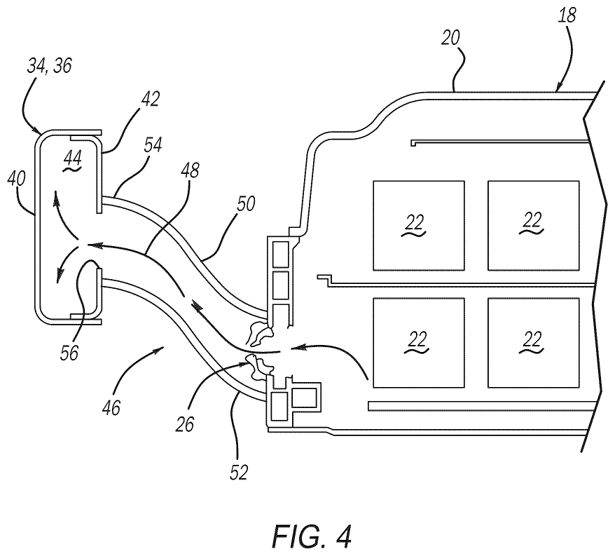

Now referring to FIGS. 1 and 3, it can be seen that vehicle 10 includes a passenger cabin 28 that can carry occupants of the vehicle 10. FIG. 3 also illustrates that battery pack 18 may be positioned beneath a portion of passenger cabin 28. If the thermal runaway event occurs when occupants are present in the passenger cabin 28, it is advantageous that the vents 26 do not release the gases of battery pack 18 during the thermal runaway event at locations where the occupants may attempt to exit vehicle 10. In addition, it is advantageous that the emergency personnel responding to the thermal runaway event be able to approach vehicle 10 and assist any occupants that may be located in passenger cabin 28. Moreover, it is advantageous for the gases of the battery pack 18 that are exiting vents 26 to not be dispersed beneath vehicle 10 where contact and ignition of combustible materials can occur. Thus, according to a principle of the present disclosure and as shown in FIGS. 3 and 4, vehicle 10 may have a venting system 30 that collects gases emitted by vents 26, directs the gases away from vehicle 10, and specifically directs the gases emitted by vents 26 away from the passenger cabin 28 of vehicle 10.

More specifically, it can be seen in FIGS. 3 and 4 that vehicle 10 includes a frame assembly 32 that supports body 12 of vehicle and battery pack 18, as well as other components of the vehicle 10 that are not illustrated (e.g., electric drive modules 16, transmission components (not shown), electrical components (not shown), vehicle HVAC system (not shown), and others). Frame assembly 32 includes a first longitudinally extending rail 34 and a second longitudinally extending rail 36 that extend substantially in parallel with one another and are connected to each other by a plurality of cross-beams 38. Battery pack 18 can be attached to and supported by a plurality of the cross-beams 38.

As best shown in FIG. 4, each of the first and second longitudinally extending rails 34, 36 are hollow structures that may be formed of a high-strength metal material such as steel, aluminum, or any other material known to one skilled in the art. In the illustrated embodiment, each of the first and second longitudinally extending rails 34, 36 includes an outer C-shaped panel 40 that is connected (e.g., welded, secured with fasteners, etc.) to an inner C-shaped panel 42. It should be understood, however, that each of the first and second longitudinally extending rails 34, 36 can be formed of a single hollow structure (i.e., panels 40 and 42 may be monolithically formed). In any event, the important aspect to keep in mind is that first and second longitudinally extending rails 34, 36 are hollow and, therefore, can be used as a conduit 44 that is part of a venting system 46 for directing the gases 48 that may be generated by the cells 22 of battery pack 18 during a thermal runaway event.

Venting system 46 includes the vents 26 provided in housing 20 of battery pack 18, the conduits 44 defined by the first and second longitudinally extending rails 34 and 36, and a connection pipe 50 that extends between housing 20 and a respective conduit 44 defined by the first and second longitudinally extending rails 34, 36. Connection pipe 50 may be formed of any material that is able to withstand the temperature of the gases 48 that are generated during the thermal runaway event. Example materials include metal materials.

Connection pipe 50 includes an open first end 52 attached to housing 20 that surrounds vent 26 and is configured for receipt of the gases 48 that are generated within housing 20 by battery cells 22, and that have exited vent 26 when the pressure within battery pack 18 has reached a predetermined level (e.g., 100 bar). Connection pipe 50 also includes an open second end 54 attached to a respective rail 34 or 36 that communicates the gases 48 into the conduit 44 defined by the respective rail 34 or 36. In this regard, the respective rail 34 or 36 can include a first aperture or inlet port 56 that permits the gases 48 to enter the conduit 44.

Again referring to FIG. 3, it can be seen that once the gases 48 enter the conduit 44 defined by at least one of the rails 34, 36, the gases 48 are free to travel through the conduit 44 defined by the respective rail (e.g., 34) before exiting the conduit 44 through at least one second aperture or outlet port 58. Importantly, it can be seen that the second aperture or outlet ports 58 are positioned away from the passenger cabin 28 of vehicle 10. In this manner, instead of permitting the gases 48 to escape battery pack 18 directly from vents 26 into the atmosphere and being dispersed beneath passenger cabin 28 where it can be difficult for the occupants to safely exit the passenger cabin 28, the gases 48 are directed to positions located forward and rearward passenger cabin 28.

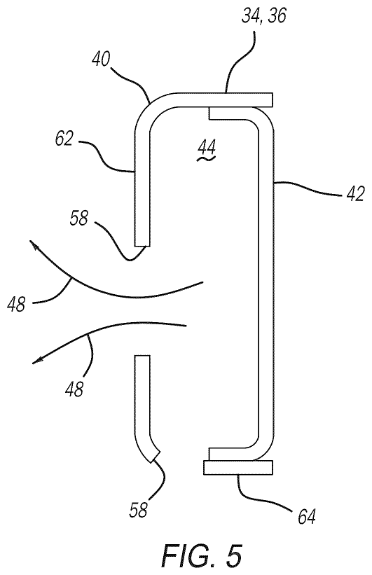

It should be understood that the second aperture or outlet ports 58 can be in the form of an aperture or hole formed in a respective rail 34, 36 or simply be an open end of the respective rail 34, 36. For example, the outlet port 58 located at a front 60 of vehicle 10 can be an open end of the respective rail 34, 36, while the outlet port 58 located aft of the passenger cabin 28 can be in the form of an aperture or hole similar to the first aperture or inlet port 56. When the outlet port 58 is formed in a manner similar to the inlet port 56, the location can be selected to direct the gases 48 in the desired direction. For example, the outlet port 58 may be formed in a side surface 62 of the panel 40 to direct the gases 48 away from body 12 of vehicle 10, or in a bottom surface 64 of the panel of the panel 40 to direct the gases in a direction toward the ground beneath the vehicle 10 (FIG. 5).

Lastly, while only rail 34 is illustrated as being in communication with connection pipe 50, it should be understood that battery pack 18 may include a plurality of vents 26 that are provided on either side of the battery pack 18 (like FIG. 2), and a connection pipe 50 can connect each vent 26 with a rail 34, 36. That is, each rail 34 and 36 can be used as a conduit 44 venting system 46, which can permit the volume of gases 48 that are generated during a thermal runaway event to be simultaneously distributed to opposing sides of vehicle 10.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a frame assembly including a first hollow longitudinally extending rail and a second hollow longitudinally rail;
a vehicle body defining a passenger cabin attached to and supported by the frame assembly;
a battery pack attached to and supported by the frame assembly, the battery pack including a plurality of battery cells housed therein; and
a venting system configured to direct gases generated by the plurality of battery cells away from the passenger cabin,
wherein the venting system includes at least one vent connected to a housing of the battery pack and in communication with a conduit defined by at least one of the first and second hollow longitudinally extending rails by a connection pipe that extends between the housing of the battery pack and the conduit, and
wherein the venting system defines a flow path were the gases generated by the plurality of battery cells exit the battery pack through the vent and enter the connection pipe before entering the conduit defined by at least one of the first and second hollow longitudinally extending rails and travelling therethrough to at least one outlet port that directs the gases away from the passenger cabin.

2. The vehicle according to claim 1, each of the first and second hollow longitudinally extending rails includes an outer C-shaped panel that is connected to an inner C-shaped panel, and an inlet port is formed in a side surface of the inner C-shaped panel that receives the gases from the connection pipe.

3. The vehicle according to claim 1, wherein venting system includes a first outlet port located at a front of the vehicle and a second outlet port located aft of the passenger cabin.

4. The vehicle according to claim 3, wherein the first outlet port is an open end of the at least one of the first and second hollow longitudinally extending rails, and the second outlet port is an aperture provided in the at least one of the first and second hollow longitudinally extending rails.

5. The vehicle according to claim 4, wherein each of the first and second hollow longitudinally extending rails includes an outer C-shaped panel that is connected to an inner C-shaped panel, and the second outlet port is formed in a side surface of the outer C-shaped panel.

6. The vehicle according to claim 4, wherein each of the first and second hollow longitudinally extending rails includes an outer C-shaped panel that is connected to an inner C-shaped panel, and the second outlet port is formed in a bottom surface of the outer C-shaped panel.

7. The vehicle according to claim 1, wherein the vent is configured to open and permit the gases to exit the battery pack after a predetermined pressure in the battery pack is reached.

8. The vehicle according to claim 4, wherein the predetermined pressure is 100 bar.

9. The vehicle according to claim 1, wherein the connection pipe is formed of a material that is resistant to a temperature of the gases generated by the plurality of battery cells.

10. The vehicle according to claim 9, wherein the connection pipe is formed of a metal material.
